(19) United States
(12) Patent Application Publication
(10) Pub. No.: US 2025/0151671 A1
(43) Pub. Date: May 15, 2025

(54) Wind Turbine and a Wind Park Comprising Such a Wind Turbine

(71) Applicant: Stichting The Global Irrigation Project, Harderwijk (NL)

(72) Inventor: Pieter Gerrit Hannessen, Harderwijk (NL)

(21) Appl. No.: 18/838,896

(22) PCT Filed: Feb. 10, 2023
(86) PCT No.: PCT/NL2023/050061

§ 371 Date: Aug. 15, 2024

(30) Foreign Application Priority Data
Feb. 18, 2022 (NL) 2031011
Nov. 22, 2022 (NL) 2033594

(51) Int. Cl. A01G 15/00; F03D 9/28; F03D 13/25

(52) U.S. Cl. CPC A01G 15/00; F03D 9/28; F03D 13/25; F05B 2240/95

(57) ABSTRACT

The present invention relates to a wind turbine, comprising: —a foundation supporting a nacelle; —a rotor that is rotatable relative to the nacelle and that comprises a plurality of rotor blades; —a fluid connection configured to connect a water intake to one or more than one output arranged above sea level; and —a pump configured to pump seawater from the water intake to the one or more than one output to thereby eject seawater containing salt particles into ambient air surrounding the wind turbine to stimulate cloud formation. The invention further relates to a wind park, comprising a plurality of wind turbines and comprising one or more than one wind turbine according to the invention.

The present invention relates to a wind turbine and to a wind park comprising such a wind turbine.

Our environment and planet are at risk, and many attempts are made to conquer environmental challenges such as global warming, scarcity of energy sources and materials, etcetera. Global warming causes drought, and may thereby negatively impact growth of plants, including vegetables and fruits that are important for food supply. One way to reduce the carbon footprint, i.e. the amount of total greenhouse gas emissions (in particular carbon dioxide and methane) released into the atmosphere as a result of the activities of a particular individual, organization, or community, is to make use of renewable energy sources such as solar energy (sunlight), wind, rain, tides, waves and geothermal heat.

Wind turbines are well known to produce electricity from the wind that acts as the renewable energy source. A wind park or wind farm, also called a wind power plant, is a group of interconnected wind turbines that are arranged relatively close to each other. By arranging a plurality of wind turbines close to each other and interconnecting them in a system, a number of advantages are obtained. For example, the wind turbines of the wind park can share a common power line from the wind turbines, that are typically offshore wind turbines, to a power station on land. It is also possible to efficiency install, maintain and—at the end of the life cycle—dismantle such wind turbines if they are arranged in a group. After all, installment, maintenance and dismantling all require dedicated equipment, that is scarse.

On a more experimental level, it is being explored if and how climate engineering, also known as geoengineering, may possibly contribute to mitigate the climate changes. For example, in an attempt to mitigate global warming, it has been proposed to spray saltwater into the air to make marine clouds brighter in colour, and thereby increase the capability of these clouds to reflect incoming solar rays. When the saltwater evaporates, salt particles remain in the air and function as a seed for clouds. This effect is similar to pollution trails left by shipping. When sea ships cross the oceans they are emitting particles into the clean air that cause a formation of marine clouds that is visible on satellite images of planet earth.

An objective of the present invention is to provide a wind turbine and a wind park, that is improved relative to the prior art and wherein at least one of the above stated problems is obviated or alleviated.

Said objective is achieved with the wind turbine according to claim 1 of the present invention, comprising:
a foundation supporting a nacelle;
a rotor that is rotatable relative to the nacelle and that comprises a plurality of rotor blades;
a fluid connection configured to connect a water intake to one or more than one output arranged above sea level; and
a pump configured to pump seawater from the water intake to the one or more than one output to thereby eject seawater containing salt particles into ambient air surrounding the wind turbine to stimulate cloud formation.

The present invention is based on the insight that wind turbines are especially suitable to combine the traditional generation of electricity based on wind energy with the formation of clouds. Combining this in a wind turbine, or even a wind park, is advantageous and provides synergistic effects, as will be explained below in more detail.

On the one hand, the wind turbine itself may produce sufficient electricity to drive the pump that is configured to pump the seawater from the water intake to the one or more than one output that are preferably arranged at a significant height, e.g. at the nacelle or even in the rotor blades. The average hub height for offshore turbines in the United States is projected to grow taller from 100 meters in 2016 to about 150 meters in 2035. The average rotor diameter for offshore turbines in the United States in 2020 was about 125 meters. However, also the turbine's rotor diameter, or the width of the circle swept by the rotating blades, increases over the years. In the offshore wind farm project called “Homsea Project One” is located off the Yorkshire coast, United Kingdom, within the Homsea Zone in the southern North Sea, the nacelles were arranged at a height of 190 m above sea level and the rotor diameter was 178 m. Summarizing, a height of about 200 m of the nacelle, and a maximum height of the blade tip, i.e. when a rotor blade is vertically upright extending relative to the monopile, exceeding 250 m is realistic nowadays, and will increase even further in the future. Pumping large amounts of seawater with a head of 200 m or more costs energy, that may be produced by the wind turbine itself, or possibly by nearby wind turbines that are part of the same wind park.

On the other hand, wind turbines are often placed offshore, where salt water is readily available. If the wind turbine is located in a situation that often faces wind directions towards the nearby land, the formation of clouds will result in additional clouds above land. After all, the clouds formed or grown by the salt particles that have been ejected into the ambient air surrounding the wind turbine, is carried by the natural wind towards the shore and further over the land. Dependent on the type of cloud being formed, the cloud may be tailored towards solar ray reflection or providing rain. If the focus is on rain fall, the most suitable types of clouds are of the cumulonimbus type and of the nimbostratus type. Especially the latter is preferred, because a nimbostratus cloud is more stable than a cumulonimbus cloud. At the same time, the nimbostratus cloud is especially capable of providing a constant rainfall over extended periods of time, allowing for the rainfall to be distributed over a larger area of land.

The present invention further relates to a wind park, comprising a plurality of wind turbines, comprising one or more than one wind turbine according to the invention. Increased result of cloud formation may be obtained if a plurality of wind turbines that are arranged near each other work together. Moreover, the electricity generated in a wind park may be used to even further stimulate cloud formation and transportation of clouds. For example, some wind turbines of the wind park may be used to actively drive the rotor of:
a cloud forming wind turbine to increase the rotational speed of the rotor blades thereof, or
a non-cloud forming wind turbine to function as a fan and thereby induce additional wind in the wind park that will transport clouds that are formed by further cloud forming wind turbines that are positioned downstream.

Optionally, some of the wind turbines in a wind park are involved in cloud formation, while other wind turbines in the wind park are involved in energy generation, such as electricity and/or hydrogen. Also optionally, wind turbines and/or the entire wind park may switch between modes of operation, for example between solar ray reflection and/or providing rain and/or generating energy.

Preferred embodiments are the subject of the dependent claims.

The invention further also relates to a system for solar ray reflection or providing rain, the system comprising a wind turbine and/or wind park according to an embodiment of the present invention.

Such system preferably further comprises computing means for gathering information about relevant climate conditions, such as temperature, humidity, wind speed, wind direction, etc. Furthermore, this information may also involve weather forecasts and/or the actual need for solar ray reflection or providing rain.

Such system further preferably comprises a controller that is preferably operatively connected to the computing means for gathering information. The controller is preferably capable of controlling the wind turbine and/or wind park. This enables performing an optimalisation for the activities of the wind turbine and/or wind park.

The invention further also relates to a method for solar ray reflection or providing rain, the method comprising the step of providing a wind turbine and/or wind park and/or system according to an embodiment of the present invention.

Such system provides the same or similar effects and advantages as described in relation to the wind turbine and/or wind park.

Such method provides the same or similar effects and advantages as described in relation to the wind turbine and/or wind park and/or system.

The method comprises the step of forming clouds to achieve the desired solar ray reflection or the providing of rain. Preferably, the method comprises an additional step of determining the need for solar ray reflection or providing rain and/or the additional step of determining the optimal operation of the wind turbine and/or wind park to optimally achieve the desired effect(s). This may involve gathering information about relevant climate conditions, such as temperature, humidity, wind speed, wind direction, etc. Furthermore, this may also involve gathering or determining weather forecasts. Optionally, gathering information may also include determining the actual need for solar ray reflection or providing rain. The gathered information can be used to determine the optimal operation of the wind turbine and/or wind park. This may include determining the time period and duration of operation of the wind turbine and/or wind park for reasons of solar ray reflection or providing rain. These additional method steps enable a further optimization of the effects of solar ray reflection or providing rain, preferably both in time and place.

The invention further also relates to a kit for adapting a wind turbine for solar ray reflection and/or providing rain, with the kit comprising a water intake, fluid connection, pump, and one or more nozzles or outputs. Such kit provides the same or similar effects as described in relation to the wind turbine, wind park, system and/or method. The kit may optionally comprise one or more of the other features described in relation to the wind turbine and/or wind park, such as a nebulizer, water reservoir, controller, additive reservoir and/or balancing system. Such kit can be used to adjust existing, conventional wind turbines and wind parks to enable solar ray reflection and/or providing rain.

The various aspects and features described and shown in the specification can be applied, individually, wherever possible. These individual aspects, and in particular the aspects and features described in the attached dependent claims, may be an invention in its own right that is related to a different problem relative to the prior art.

In the following description preferred embodiments of the present invention are further elucidated with reference to the drawing, in which:

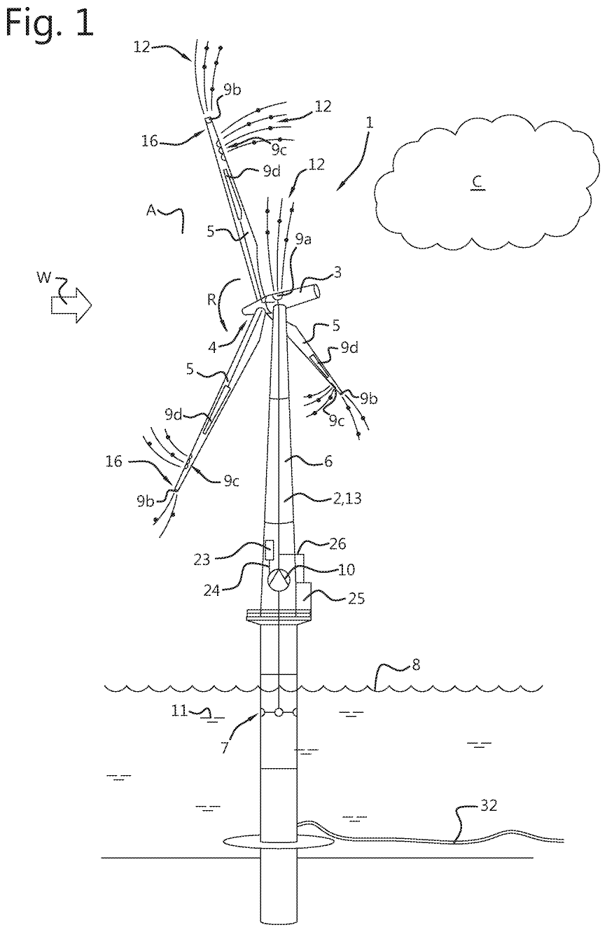

FIG. 1 is a perspective view of a wind turbine according to the invention;

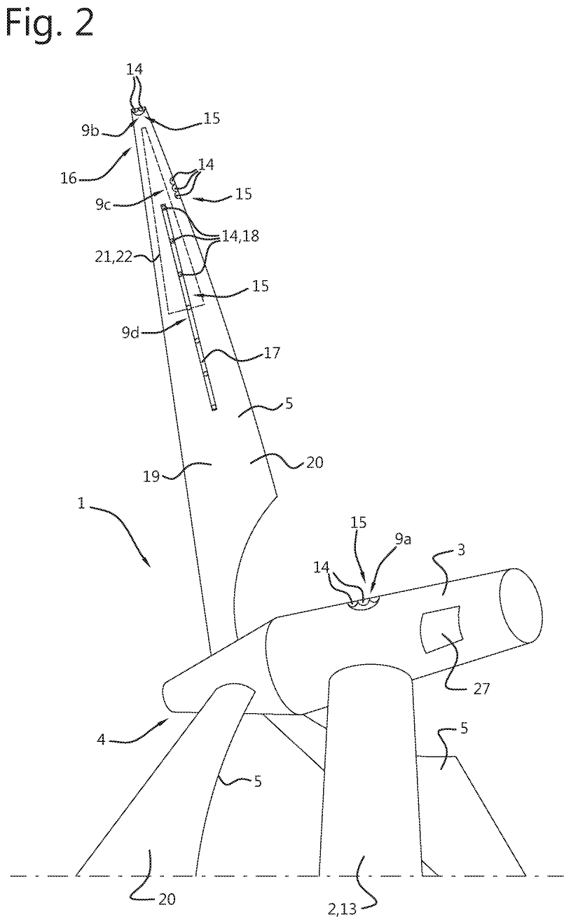

FIG. 2 is a detailed perspective view of the wind turbine of FIG. 1;

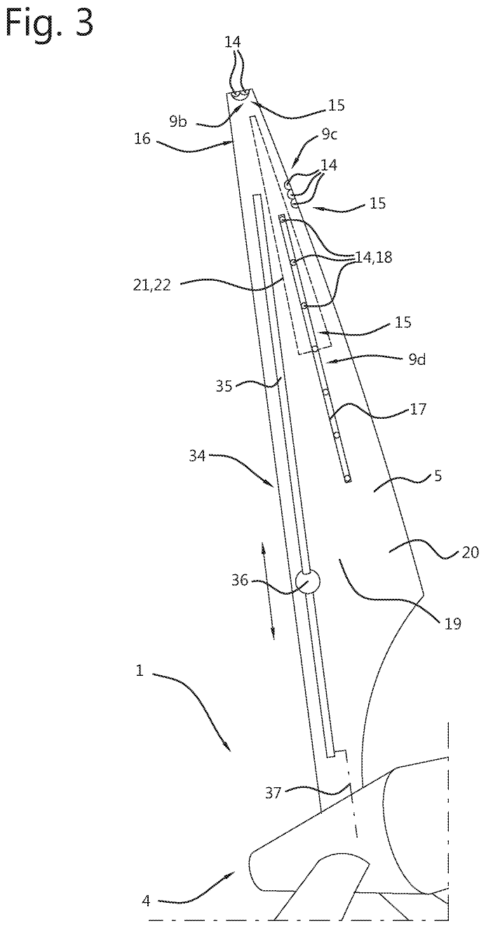

FIG. 3 is a detailed perspective view of a rotor blade;

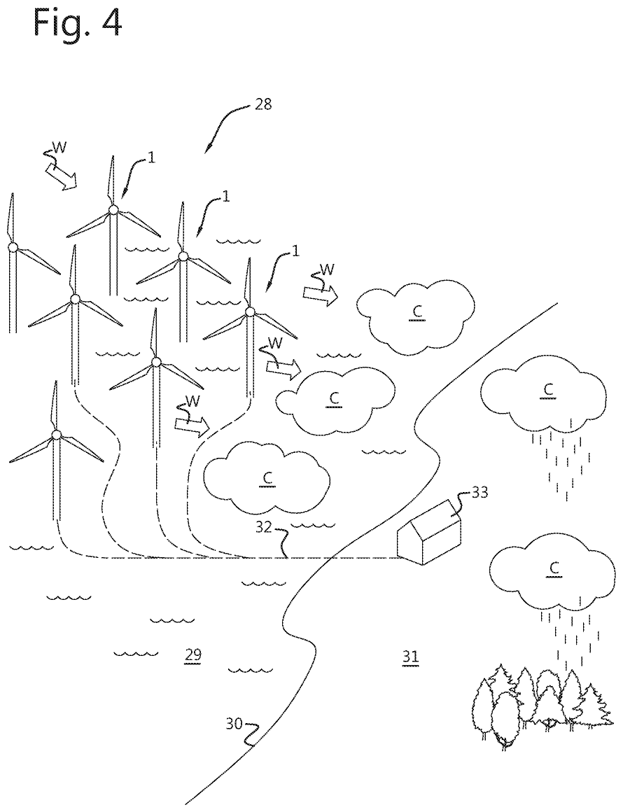

FIG. 4 is a perspective view of a wind park according to the invention;

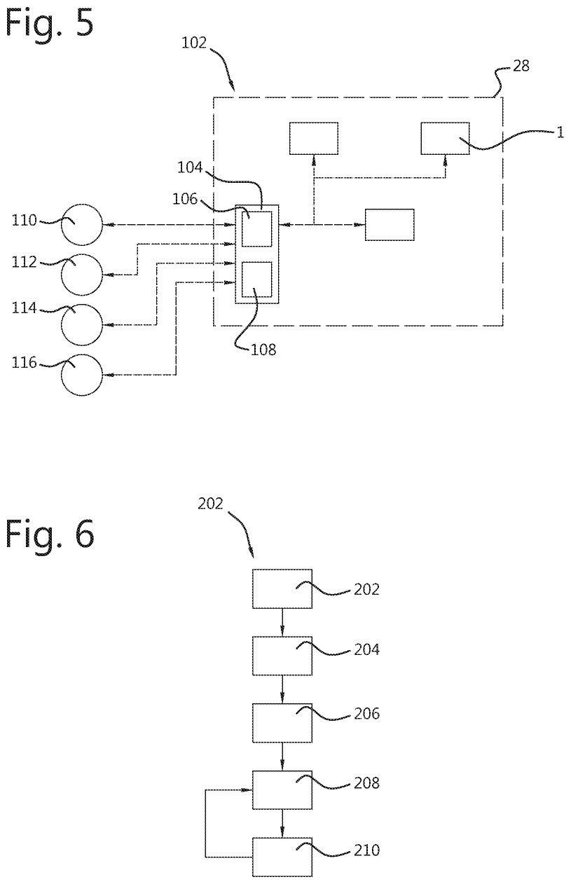

FIG. 5 is a schematic view of a system according to the invention; and

FIG. 6 is a schematic overview of steps in an embodiment of a method according to the invention.

The wind turbine 1 shown in FIG. 1 comprises a foundation 2 supporting a nacelle 3 and a rotor 4 that is rotatable relative to the nacelle 3 and that comprises a plurality of rotor blades 5. The wind turbine 1 further comprises a fluid connection 6 with an optional rotary joint, with fluid connection 6 being configured to connect a water intake 7 below sea level 8 to one or more than one output 9a-9d arranged above sea level 8. A pump 10 is configured to pump seawater 11 from the water intake 7 to the one or more than one output 9a-9d to thereby eject seawater 11 containing salt particles 12 into ambient air A surrounding the wind turbine to stimulate cloud C formation.

Although the foundation 2 is embodied as a monopile tower 13 in the embodiment shown in the Figures, it is explicitly mentioned that the invention may also be applied to wind turbines 1 that are supported by a different type of foundation 2, such as (not shown) jackets.

Although it is possible that a wind turbine 1 on land is supplied with seawater 11, possibly indirectly via a (not shown) buffer tank that is in fluid connection with the water intake 7 remote in sea, the wind turbine 1 is preferably an offshore wind turbine 1. When the wind turbine 1 is arranged offshore, i.e. in the sea, salt seawater 11 is readily available.

In order to stimulate the formation of aerosols and thereby the formation of clouds C, the one or more than one output 9A-9d may comprise one or more than one nozzle 14, and the one or more than one nozzle 14 defines a nebulizer 15 that is configured to nebulize the seawater 11 containing salt particles 12.

It is mentioned here that the exemplary embodiment shown in FIGS. 1 and 2 shows a variety of positions where the output 9a-9d may be positioned, such as the output 9a in the nacelle 3, and the output 9b-9d in the one or more than one rotor blade 5. Output 9a can be positioned on either side or both sides of rotor(s) 4. The skilled person will acknowledge that these positions are merely different examples shown in one and the same Figure. Although they may be applied in combination, this is not essential. It is even possible that individual rotor blades 5 comprises different variations of outputs 9b-9d, or that outputs 9b-9d are absent in some rotor blades 5.

The one or more than one output 9b-9d is preferably arranged at the one or more than one rotor blade 5. The rotational speed of the rotor blade 5 in the rotating direction R may stimulate the formation of aerosols out of the seawater 11.

If the one or more than one output 9b is arranged is arranged at a tip 16 of the rotor blade 6 and configured to eject the seawater 11 containing salt particles 12 radially outward relative to the tip 16, it is possible to eject the seawater 11 with salt particles 12 at the highest point available. Moreover, the ejection may benefit from the centrifugal force due to the rotation R of the rotor 4, allowing the seawater 11 with salt particles 12 to reach even higher. Furthermore, if the seawater 11 is ejected out of the output 9b by centrifugal force, it causes an under pressure or vacuum that causes or contributes to seawater 11 being displaced from the nacelle 3 into the rotor blades 5 towards the output 9b at the tip 16.

If the one or more than one output 9d is arranged in a longitudinal direction of the rotor blade 5, the seawater 11 with salt particles 12 may be distributed over a large area. For example, the one or more than one output 9d may be arranged in a distributed arrangement, such as by providing a porous dripping hose 17 and/or by arranging openings 18 or nozzles 14 distributed along the longitudinal direction of the rotor blade 5.

The one or more than one output 9d may be arranged at a suction side 19 of the rotor blade 5, allowing the negative pressure at said suction side 19 to suck the seawater 11 out of the output 9d and subsequently carry the seawater 11 with salt particles 12 away with the air flowing around the rotor blade 5.

Effective use of the turbulent air flow at the trailing edge 20 of the rotor blade 5 is advantageously used if the one or more than one output 9c is arranged along at least a part of the trailing edge 20 of the rotor blade 5. This turbulent flow distributes the seawater 11 with salt particles 12 effectively, thereby promoting evaporation of the liquid and the formation of aerosols that contribute to cloud C formation.

The one or more than one rotor blade 5 may comprise a water reservoir 21 that is configured to store seawater 11. The water reservoir 21 is preferably arranged in a radially outward half of the rotor blade 5 that is defined between the tip 16 and halfway a length of the rotor blade 5. In this radially outward half of the rotor blade 5, the rotational speed is relatively high. It is therefore advantageous to eject the seawater 11 with salt particles 12 in this outer half of the rotor blade 5. A balancing mass 36 that is moveable in a longitudinal direction of the rotor blade 5 may be provided in each one of the rotor blades 5. An example of a balancing system 34 comprising such a balancing mass 36 that is moveable along an elongate rails 35 that extends in a longitudinal direction of a rotor blade 5 is shown in FIG. 3. This rotor blade 5 of FIG. 3 closely resembles the rotor blade 5 of FIG. 2, but the water reservoir 21 is positioned slightly different in order to provide sufficient space for the balancing system 34. By selectively moving the balancing mass 36 inside the rotor blade 5, e.g. moving said balancing mass 36 radially outward and away from the nacelle 3 towards the tip 16, the total rotor 4 supporting the plurality of rotor blades 5 may be balanced even if a water reservoir 21 in one or more than one of the rotor blades 5 is being filled with seawater 11. Control line 37 may be connected to the controller 23 to actively control the position of the balancing mass 36.

In an alternative embodiment, arranging the water reservoir 21 is the outer half of the rotor blade 5 is used to deliberately adjust the mass of the rotor blade 5. It is for example envisaged to pump seawater 11 into the water reservoir 21 of a specific rotor blade 5 during or shortly before a downward movement of said rotor blade 5, allowing the additional weight of the seawater 11 in the rotor blade 5 to cause an additional gravitational force on the downward moving rotor blade 5. If the same rotor blade 5 starts to move upward again, the seawater 11 may be ejected. Dependent on the timing of the filing and the emptying of the seawater 11 in the water reservoir 21, the additional mass of the seawater 11 may contribute to the rotational speed of the rotor 4. In this alternative embodiment, the mechanical construction must be designed to withstand the imbalances that will occur.

The water reservoir 21 may comprise an elastic bladder 22 and/or be pressurized to thereby allow the ejection of seawater 11 to occur relative fast. In this way it is possible to control where and when the seawater 11 with salt particles 12 is sprayed into the ambient air A surrounding the wind turbine 1.

The wind turbine 1 may further comprise a controller 23 that is configured to control the pump 10 and/or the one or more than one output 9a-9d to selectively eject the seawater 11 containing salt particles 12 in a pre-determined angular range of a revolution of the rotor blade 5. In FIG. 1, only a control line 24 between the controller 23 is shown, but additional (not shown) control lines and valves may be present between the controller 23 and the one or more than one output 9a-9d to allow the outputs to be controlled independently from each other.

The pre-determined angular range where the seawater 11 with salt particles 12 is ejected is preferably situated in one or more than one of: in an upper half of the revolution and in an upward movement of the rotor blade 5. Ejecting the seawater in the upper half of the revolution guarantees that the seawater 11 with salt particles 12 is ejected relatively high. Ejecting in an upward movement of the rotor blade 5 reduces the weight of the rotor blade 5 during upward movement, allowing for an energy saving.

The one or more than one output 9a may also be arranged on the nacelle 3, which is already relatively high, and because it is a part directly supported by the foundation 2, the construction may be relatively simple and therefore reliable and robust. Moreover, arranging the output 9a on the nacelle 3 also allows the seawater 11 with particles 12 to be ejected at a predetermined horizontal offset downstream of the rotor blades 5, and will therefore not or less effect the rotor blades 5. The turbulent air flow in this area may contribute to the formation of clouds C.

The one or more than one output 9a that is arranged on the nacelle 3 may be configured to eject the seawater 11 containing salt particles 12 in one or more than one of an upward direction and a horizontal direction, and preferably in a slipstream of the wind turbine 1.

The wind turbine 1 may further comprise an additive reservoir 25 configured to store additives. The additives preferably comprise nutrients or seeds, and may be added to the seawater 11 in transported via the fluid connection 6 via a feed line 26 that is preferably connected to the fluid connection 6 downstream of the pump 10. Alternatively, the additives may comprise chemicals contributing to cloud formation.

The wind turbine 1 may further comprise a drive 27 configured to rotatably drive the rotor 4 like a fan.

FIG. 4 shows a wind park 28 comprising a plurality of wind turbines 1 and comprising one or more than one wind turbine 1 according to the invention. The wind turbines 1 are placed offshore, i.e. in the sea 29, where salt water is readily available. In FIG. 2, the wind direction W is directed towards the shore 30 and the nearby land 31. Consequently, the formation of clouds C will result in additional clouds C above land 31. After all, the clouds C formed or grown by the salt particles 12 that have been ejected into the ambient air A surrounding the wind turbine 1, is carried by the natural wind W towards the shore 30 and further over the land 31. A power line 32 connects the wind turbines 1 of the wind park 28 to a power station 33 on the land 31. Wind parks 28 may also produce hydrogen gas.

One or more than one wind turbine 1 that is arranged at a downstream side of the wind park 28 relative to the wind direction W may be configured and controlled to eject seawater 11 containing salt particles 12 into ambient air A surrounding the wind turbine 1. In this way, the salt particles 12 are transported away from the wind park 28, thereby preventing the salt particles 12 ejected by the wind turbine at this downstream side of the wind park 28 to accumulate on other wind turbines 1. The clouds C are formed downstream of the wind park 28.

The wind turbine 1 that is arranged at the downstream side of the wind park 28 relative to the wind direction W may be a wind turbine 1 comprising a drive 27 that is configured to rotatably drive the rotor 4 like a fan, wherein the drive 27 drives the rotor to increase the rotation speed of the rotor blades 5. A higher rotation speed of the rotor blades correlates to improved forming of aerosols and clouds C.

The drive 27, and possibly also the pump 10, of the wind turbine 1 that is arranged at the downstream side of the wind park 28 relative to the wind direction W may be powered by electricity that is generated by one or more than one further wind turbine 1 of the wind park 28.

One or more than one wind turbine 1 that is arranged at an upstream side of the wind park 28 relative to the wind direction W may be a wind turbine 1 comprising a drive 27 that is configured to rotatably drive the rotor 4 like a fan and thereby induce additional wind.

System 102 comprising a number of wind turbines 1 is shown in FIG. 5. Wind turbines 1 are part of wind park 28. In the illustrated embodiment system controller 104 comprises computing means 106 for gathering data and further comprises controller 108 for controlling wind turbines 1 of wind park 28. Data originates form operational information 110, weather forecasts 112, actual weather conditions 114, and the actual need or predicted need for solar ray reflection or rain 116. This data can be gathered from external data sources and/or collected directly by system 102. System controller 104 may send operational data to other systems or operators. System controller 104 further sends instructions to the individual wind turbines 1, optionally to local sub-controllers, such as controller 23 of such wind turbine 1. Controller 106 optionally performs an optimization to determine which of wind turbines 1 should operate at which time and for how long. Also, rotor speed, water flow, and amounts of additives added to the flow can be optimized for each individual wind turbine 1.

FIG. 6 shows an embodiment of a method 201 for solar ray reflection and/or providing rain according to the invention. Method 201 describes the operation of wind turbine 1 and/or wind park 28. It will be understood that wind turbine 1 and wind park 28 are installed after a design and manufacturing process 202 that preferably considers the local circumstances and needs. In step 204 the actual and/or forecasted need for solar ray reflection and/or providing rain is determined. In step 206 information is gathered about operational information, weather forecasts, actual weather conditions, etc. Control step 208 controls the actual operation of wind turbine 1 and/or wind park 28 and/or system 102. Monitoring step 210 controls the actual operation of wind turbine 1 and/or wind park 28 and/or system 102, and preferably the desired effects of solar ray reflection and/or providing rain, and feeds the observations back to control step 208 to optimize and/or control the actual operation.

The above-described embodiment is intended only to illustrate the invention and not to limit in any way the scope of the invention. Although a traditional wind turbine comprising a rotor 4 having a substantially horizontal rotation axis is shown to elucidate the invention, the principle of ejecting sea water 11 with salt particles 12 may also be applied to other types of wind turbines, such as wind turbines having a substantially vertical rotation axis.

It should be understood that where features mentioned in the appended claims are followed by reference signs, such signs are included solely for the purpose of enhancing the intelligibility of the claims and are in no way limiting on the scope of the claims. The scope of protection is defined solely by the following claims. The present invention is by no means limited to the above-described preferred embodiments thereof. The rights sought are defined by the following claims within the scope of which many modifications can be envisaged.

1. Wind turbine, comprising:
a foundation supporting a nacelle;
a rotor that is rotatable relative to the nacelle and that comprises a plurality of rotor blades;
a fluid connection configured to connect a water intake to one or more than one output arranged above sea level; and
a pump configured to pump seawater from the water intake to the one or more than one output to thereby eject seawater containing salt particles into ambient air surrounding the wind turbine to stimulate cloud formation.

2. The wind turbine according to claim 1, wherein the wind turbine is an offshore wind turbine, and the water intake is arranged below sea level.

3. The wind turbine according to claim 1, wherein the one or more than one output comprises one or more than one nozzle, and the one or more than one nozzle defines a nebulizer that is configured to nebulize the seawater containing salt particles.

4. The wind turbine according to claim 3 wherein the one or more than one output is arranged at the one or more than one rotor blade.

5. The wind turbine according to claim 4, wherein the one or more than one output is arranged at a tip of the rotor blade and configured to eject the seawater containing salt particles radially outward relative to the tip.

6. The wind turbine according to claim 4, wherein the one or more than one output is arranged in a longitudinal direction of the rotor blade.

7. The wind turbine according to claim 6, wherein the one or more than one output is arranged at a suction side of the rotor blade and/or wherein the one or more than one output is arranged along at least a part of a trailing edge of the rotor blade.

8. (canceled)

9. The wind turbine according to claim 4, wherein the one or more than one rotor blade comprises a water reservoir configured to store seawater.

10. The wind turbine according to claim 9, wherein the water reservoir is arranged in a radially outward half of the rotor blade that is defined between the tip and halfway a length of the rotor blade and/or wherein the water reservoir is pressurized and/or wherein the water reservoir comprises an elastic bladder.

11. (canceled)

12. (canceled)

13. The wind turbine according to claim 4, further comprising a controller that is configured to control the pump and/or the one or more than one output to selectively eject the seawater containing salt particles in a pre-determined angular range of a revolution of the rotor blade.

14. (canceled)

15. The wind turbine according to claim 10, wherein the pre-determined angular range is situated in an upper half of the revolution and/or wherein the pre-determined angular range comprises an upward movement of the rotor blade.

16. The wind turbine according to claim 1, wherein the one or more than one output is arranged on the nacelle, and wherein the one or more than one output is configured to eject the seawater containing salt particles in an upward direction and/or wherein the one or more than one output is configured to eject the seawater containing salt particles in a horizontal direction and/or wherein the one or more than one output is configured to eject the seawater containing salt particles in a slipstream of the wind turbine.

17.-19. (canceled)

20. The wind turbine according to claim 1, comprising an additive reservoir configured to store additives, wherein the additives preferably comprise nutrients or seeds.

21. The wind turbine according to claim 1, further comprising a drive configured to rotatably drive the rotor like a fan.

22. A wind park, comprising:
a plurality of wind turbines, comprising one or more than one wind turbine, wherein the wind turbine comprising:
a foundation supporting a nacelle;
a rotor that is rotatable relative to the nacelle and that comprises a plurality of rotor blades:
a fluid connection configured to connect a water intake to one or more than one output arranged above sea level, and
a pump configured to pump seawater from the water intake to the one or more than one output to thereby eject seawater containing salt particles into ambient air surrounding the wind turbine to stimulate cloud formation.

23. The wind park according to claim 22, wherein one or more than one wind turbine that is arranged at a downstream side of the wind park relative to the wind direction is configured and controlled to eject seawater containing salt particles into ambient air surrounding the wind turbine.

24. The wind park according to claim 23, wherein the wind turbine that is arranged at the downstream side of the wind park relative to the wind direction is a wind turbine, further comprising a drive configured to rotatably drive the rotor like a fan, wherein the drive drives the rotor to increase the rotation speed of the rotor blades, wherein the drive of the wind turbine that is arranged at the downstream side of the wind park relative to the wind direction is powered by electricity that is generated by one or more than one further wind turbine of the wind park, wherein one or more than one wind turbine that is arranged at an upstream side of the wind park relative to the wind direction is a wind turbine further comprising a drive configured to rotatably drive the rotor like a fan that is configured to function as a fan and thereby induce additional wind.

25.-27. (canceled)

28. A method for solar ray reflection or providing rain, the method comprising the step of providing a wind turbine and/or wind park, wherein the wind turbine comprises:
a foundation supporting a nacelle:
a rotor that is rotatable relative to the nacelle and that comprises a plurality of rotor blades;
a fluid connection configured to connect a water intake to one or more than one output arranged above sea level; and
a pump configured to pump seawater from the water intake to the one or more than one output to thereby eject seawater containing salt particles into ambient air surrounding the wind turbine to stimulate cloud formation.

29. The method according to claim 28, further comprising the step of forming clouds to achieve the desired solar ray reflection or the providing of rain, and/or further comprising the step of determining the need for solar ray reflection or providing rain and/or the determining the optimal operation of the wind turbine and/or wind park.

30. (canceled)

31. The method according to claim 28, further comprising the step of gathering information about relevant climate conditions and/or gathering or determining weather forecasts and further comprising the step of determining the optimal operation of the wind turbine and/or wind park.

32. (canceled)

33. (canceled)
